(19) United States
(12) Patent Application Publication
(10) Pub. No.: US 2022/0065746 A1
(43) Pub. Date: Mar. 3, 2022

(54) Detection method for radial deformation of flexspline of harmonic reducer under installation eccentricity state

(71) Applicant: BEIJING UNIVERSITY OF TECHNOLOGY, BEIJING (CN)

(72) Inventors: Congbin YANG, BEIJING (CN); Qingxu Guo, BEIJING (CN); Zhifeng LIU, BEIJING (CN); Yongsheng ZHAO, BEIJING (CN); Caixia ZHANG, BEIJING (CN); Qiang CHENG, BEIJING (CN)

(21) Appl. No.: 17/521,756

(22) Filed: Nov. 8, 2021

Related U.S. Application Data
(63) Continuation of application No. PCT/CN2020/100957, filed on Jul. 9, 2020.

(30) Foreign Application Priority Data
Feb. 14, 2020 (CN) 202010092620.8

(51) Int. Cl. G01M 13/021

(52) U.S. Cl. CPC G01M 13/021; B25J 9/1025

(57) ABSTRACT

The invention discloses a detection method for radial deformation of flexspline of harmonic reducer under installation eccentricity state, taking the center of wave generator as the origin, the reference coordinate system is established in the method, and the offset between the center of wave generator and the pivotal center of rotary table is calculated by measuring the standard circle coaxial with the wave generator; the radial deformation function and the offset of wave generator under eccentricity state are taken to the theoretical ellipse eccentricity mathematical model to obtain the parameters of the actual ellipse; the offset and ellipse parameters are taken into the radial runout correction model of the flexspline to obtain the correction model under eccentricity state; the flexspline deformation function is measured and the correction model is taken to obtain the radial deformation function of the flexspline under standard state. This method solves the problem of installation eccentricity in the process of deformation detection of the flexspline, and obtains a more accurate variation function of the flexspline, and provides a more accurate practical basis for the design and optimization of the tooth shape.

### CROSS-REFERENCE TO RELATED APPLICATIONS

This application is a continuation of International Application No. PCT/CN2020/100957, filed on Jul. 9, 2020, which claims priority to Chinese Patent Application No. 202010092620.8, filed on Feb. 14, 2020. The contents of the above applications are hereby incorporated by reference in their entireties and form a part of this specification.

### FIELD OF THE INVENTION

The invention relates to the technical field of harmonic reducer detection, and more particularly, a detection method for the radial deformation of flexspline under installation eccentricity state.

### BACKGROUND TECHNOLOGY

Harmonic reducer is the core component of robot joint. The flexspline and rigid gear of harmonic reducer engage in meshing drive, which has the advantages of small volume, high rotation ratio, large bearing capacity and high drive accuracy. There are the problems of unstable drive, time-varying rigidity and forced vibration and so on in the process of harmonic drive, and the main reason of which is the large deformation of flexspline will lead to the complex drive process of harmonic reducer. At present, most detection methods need high installation accuracy, and the detection accuracy of flexspline deformation function is not high, and there is still no study on the flexspline deformation function under installation eccentricity state.

### SUMMARY OF THE INVENTION

The purpose of the invention is to improve the detection accuracy of the flexspline deformation function of the harmonic reducer, and solve the problem that the device precision is too high to be met. By studying the profile difference of the wave generator under eccentricity state, a detection method of the radial deformation of the flexspline under installation eccentricity state is proposed.

The technical scheme adopted in the invention is as follows:

A detection method for radial deformation of flexspline of harmonic reducer under installation eccentricity state, taking the center of wave generator as the origin, the reference coordinate system is established, and the offset (eₓ,e_{y}) between the center of wave generator and the pivotal center of rotary table is calculated by measuring the standard circle coaxial with the wave generator; the radial deformation function and the offset (eₓ,e_{y}) of wave generator under eccentricity state are taken to the theoretical ellipse eccentricity mathematical model to obtain the parameters (a,b) of the actual ellipse; offset (eₓ,e_{y}) and ellipse parameters (a,b) are taken into the radial runout correction model of the flexspline to obtain the correction model under eccentricity state; the flexspline deformation function is measured and the correction model is taken to obtain the radial deformation function of the flexspline under standard state.

W1. Establish reference coordinate system

Taking the center of wave generator as the origin, the reference coordinate system O is established. In this coordinate, the eccentric coordinate of the pivotal center of rotary table is (eₓ,e_{y}).

W2. Establish the function model of standard circle and the function model of ellipse under theoretical eccentricity state

1) Standard circle under eccentricity state

In the reference coordinate system O, r is the radius of standard circle; eₓ is the offset of measuring line; r₀ is the radius of eccentric circle; d₀ is the distance variation of measuring points; θ is the rotation angle. The function model of standard circle under eccentricity state is as follows:

$$\{ \begin{matrix}{b}^{2} + {d}_{1}^{2} - 2 {bd}_{1} cos ( w ) = {r}^{2} \\ {d}_{1} - r - \sqrt{{r}^{2} - {e}_{x}^{2}} = {d}_{0} \end{matrix} \\ therein \text{:} cos δ = \frac{{e}_{x}}{{r}_{0}} ; cos ( w ) = \frac{{e}_{x} {r}_{0} cos ( δ - θ )}{{r}_{0}^{2} - b \sqrt{{r}_{0}^{2} - {e}_{x}^{2}}} \qquad ( 1 \text{-} 1 )$$

According to the above formula, the function model of standard circle under eccentricity state is obtained: d₀=f (0) . The measured parameters of standard circle are respectively taken into the above formula to obtain the offset of actual circle (eₓ,e_{y}).

2) Elliptic curve under eccentricity state

The coordinate system is established with the ellipse center as the center, B is the rotation angle. Set the focus of the measuring line and the ellipse as (x, y), and the coordinate of the rotation center as (eₓ,−e_{y}).

$$\begin{matrix}( x , y ) = \{ \begin{matrix}\frac{{x}^{2}}{{a}^{2}} + \frac{{y}^{2}}{{b}^{2}} = 1 \\ cos δ = \frac{{e}_{x}}{\sqrt{{( x - {e}_{x} )}^{2} + {( y + {e}_{y} )}^{2}}} \\ cos δ = \frac{- x + {e}_{x}}{\sqrt{{( x - {e}_{x} )}^{2} + {( y + {e}_{y} )}^{2}}} \\ w + θ = δ \end{matrix} & ( 1 \text{-} 2 ) \\ d = \sqrt{{( x - {e}_{x} )}^{2} + {( y + {e}_{y} )}^{2} - {e}_{x}^{2}} & ( 1 \text{-} 3 )\end{matrix}$$

The wave generator function and offset (eₓ,e_{y}) are respectively taken into the above formula, actual ellipse parameters a and b can be obtained.

W3. Establish the correction model A of the flexspline deformation function under theoretical eccentricity state

In the reference coordinate system O, the correction model of flexspline deformation function under eccentricity state is obtained, which includes two parts: the correction model of wave generator eccentricity error and the correction model of interval eccentricity error.

A=D+τ

The eccentricity error model of wave generator is the differential function D between wave generator B under standard state and wave generator function model C under eccentricity state:

$$D = B - C$$

$$therein \text{:} B = \frac{ab}{\sqrt{{a}^{2} {cos}^{2} θ + {b}^{2} {sin}^{2} θ}}$$

C: Measure the wave generator function by laser rangefinder

The interval eccentricity error correction model refers to the error model of the flexible bearing and the thickness of flexspline under eccentricity state, which is the interpolation function τ between standard value and eccentric value.

τ=β−β₁

is the interval variation function under theoretical state; β₁ is the interval variation function under eccentricity state.

The interval variation function β under theoretical state:

$$\{ \begin{matrix}{ρ}_{1} = \frac{ab}{\sqrt{{a}^{2} {cos}^{2} φ + {b}^{2} {sin}^{2} φ}} \\ {ρ}_{2} = \frac{( a + Δ ) ( b + Δ )}{\sqrt{{( b + Δ )}^{2} {cos}^{2} φ + {( b + Δ )}^{2} {sin}^{2} φ}} \\ β = {ρ}_{2} - {ρ}_{1} \end{matrix} \qquad ( 1 \text{-} 4 )$$

therein Δ is the thickness.

The interval variation function β₁ under eccentricity state:

The elliptic function parameters a1 and b1 where the flexspline is located and the wave generator parameters a2 and b2 are respectively taken into the above formula (1-2), and (x₁, y₁) , (x₂, y₂) are respectively obtained and taken into the following formula, and β₁=\sqrt{(x₁−x₂)²+(y₁−y₂)²} (1-5) is obtained.

W4. Measure coaxial standard circle and wave generator parameter C and flexspline deformation parameter E

The deformation parameters of coaxial standard circle, wave generator and flexspline are respectively measured by rotary table and laser rangefinder. The deformation function C of wave generator under eccentric action is obtained.

W5. Establish the correction model A1 under eccentricity state

The eccentricity (eₓ,e_{y}) is obtained by measured parameters of standard circle under eccentricity state and then taken to the formula to obtain the correction model A1 of the radial deformation function of the flexspline under eccentricity (eₓ,e _{y}) state.

W6. Corrected radial deformation function of flexspline

The radial deformation correction model A1 of the flexspline under eccentricity (eₓ,e _{y}) state established in W5 is taken to the flexspline deformation function model E measured under eccentricity state:

Q=E+A1

Q is the radial deformation function model of flexspline under standard state.

The advantages and positive effects of the invention are as follows:

The offset is obtained by analyzing the trajectory change of the standard circle under eccentricity state in the invention; the error parameter of wave generator in actual processing is obtained by analyzing the change of the standard ellipse under eccentricity state; taking the detection of the wave generator as the calibration reference, a more accurate deformation function model is obtained by correcting the deformation function of the flexspline under eccentricity state using a certain algorithm. The invention solves the problem exorbitant accuracy demands of the device.

### DESCRIPTION OF DRAWINGS

FIG. 1 is a flow chart of radial deformation detection of flexspline under installation eccentricity state;

FIG. 2 is schematic diagram of detection device for radial deformation of flexspline;

FIG. 3 is a representation of the correction model of flexspline deformation function;

FIG. 4 is an experimental flow chart of radial deformation of flexspline under eccentricity state.

Therein: 1-rotary table, 2-base, 3-rotating shaft, 4-bearing, 5-wave generator, 6-flexspline.

### Exemplary Embodiment

In order to further understand the content, characteristics and effect of the invention, the following embodiments in coordination with the description of drawings are cited to illustrate in detail as follows:

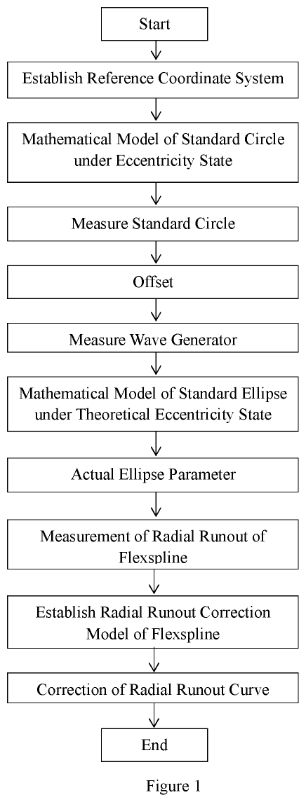

A detection method for radial deformation of flexspline of harmonic reducer under installation eccentricity state is shown in FIG. 1, taking the center of wave generator as the origin, the reference coordinate system is established, and the offset (eₓ,e_{y}) between the center of wave generator and the pivotal center of rotary table is calculated by measuring the standard circle coaxial with the wave generator; the radial deformation function and the offset (eₓ,e _{y}) of wave generator under eccentricity state are taken to the theoretical ellipse eccentricity mathematical model to obtain the parameters (a,b) of the actual ellipse; offset (eₓ,e_{y}) and ellipse parameters (a, b) are taken into the radial runout correction model of the flexspline to obtain the correction model under eccentricity state; the flexspline deformation function is measured and the correction model is taken to obtain the radial deformation function of the flexspline under standard state.

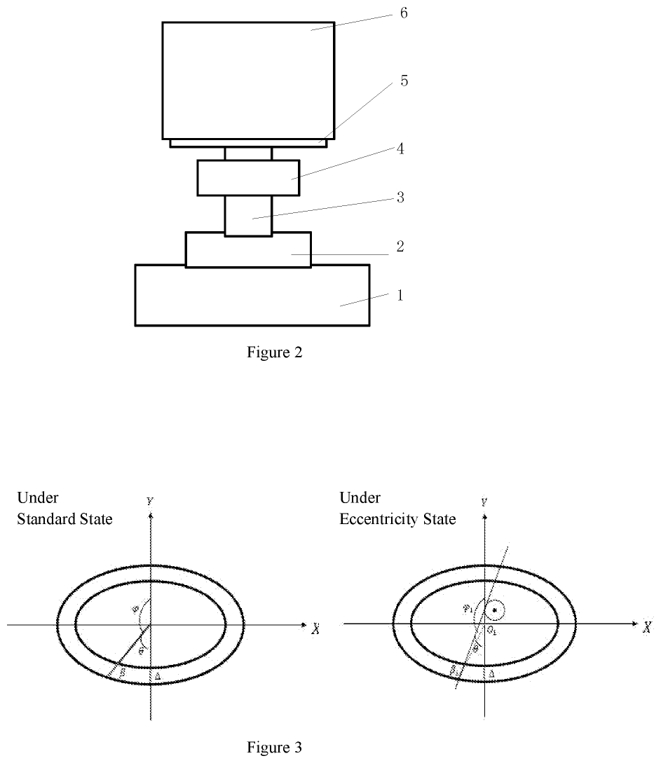

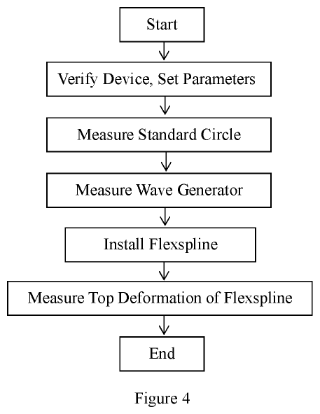

As shown in FIG. 2, the device is installed on the rotary table 1, the rotating shaft 3 is installed on the rotary table 2 by the base 2, the standard bearing 4 and the wave generator 5 are installed on the rotating shaft, and the upper flexspline 6 is fixed by the bracket.

The method consists of the following steps:

W1. Establish reference coordinate system

Taking the center of wave generator as the origin, the reference coordinate system O is established. In this coordinate, the eccentric coordinate of the pivotal center of rotary table is (eₓ,e_{y}).

W2. Establish the function model of standard circle and the function model of ellipse under theoretical eccentricity state

1) Standard circle under eccentricity state

In the reference coordinate system O, r is the radius of standard circle; eₓ is the offset of measuring line; r₀ is the radius of eccentric circle; d₀ is the distance variation of measuring points; θ is the rotation angle. The function model of standard circle under eccentricity state is as follows:

$$\{ \begin{matrix}{b}^{2} + {d}_{1}^{2} - 2 {bd}_{1} cos ( w ) = {r}^{2} \\ {d}_{1} - r - \sqrt{{r}^{2} - {e}_{x}^{2}} = {d}_{0} \end{matrix} \\ therein \text{:} cos δ = \frac{{e}_{x}}{{r}_{0}} ; cos ( w ) = \frac{{e}_{x} {r}_{0} cos ( δ - θ )}{{r}_{0}^{2} - b \sqrt{{r}_{0}^{2} - {e}_{x}^{2}}} \qquad ( 1 \text{-} 1 )$$

According to the above formula, the function model of standard circle under eccentricity state is obtained: d₀=f (θ) . The measured parameters of standard circle are respectively taken into the above formula to obtain the offset of actual circle (eₓ,e_{y}).

2) Elliptic curve under eccentricity state

The coordinate system is established with the ellipse center as the center, θ is the rotation angle. Set the focus of the measuring line and the ellipse as (x, y), and the coordinate of the rotation center as (eₓ,−e_{y}).

$$\begin{matrix}( x , y ) = \{ \begin{matrix}\frac{{x}^{2}}{{a}^{2}} + \frac{{y}^{2}}{{b}^{2}} = 1 \\ cos δ = \frac{{e}_{x}}{\sqrt{{( x - {e}_{x} )}^{2} + {( y + {e}_{y} )}^{2}}} \\ cos δ = \frac{- x + {e}_{x}}{\sqrt{{( x - {e}_{x} )}^{2} + {( y + {e}_{y} )}^{2}}} \\ w + θ = δ \end{matrix} & ( 1 \text{-} 2 ) \\ d = \sqrt{{( x - {e}_{x} )}^{2} + {( y + {e}_{y} )}^{2} - {e}_{x}^{2}} & ( 1 \text{-} 3 )\end{matrix}$$

The wave generator function and offset (eₓ,e _{y}) are respectively taken into the above formula, actual ellipse parameters a and b can be obtained.

W3. Establish the correction model A of the flexspline deformation function under theoretical eccentricity state

In the reference coordinate system O, the correction model of flexspline deformation function under eccentricity state is obtained, which includes two parts: the correction model of wave generator eccentricity error and the correction model of interval eccentricity error.

A=D+τ

The eccentricity error model of wave generator is the differential function D between wave generator B under standard state and wave generator function model C under eccentricity state:

$$D = B - C$$

$$therein \text{:} B = \frac{ab}{\sqrt{{a}^{2} {cos}^{2} θ + {b}^{2} {sin}^{2} θ}}$$

C: Measure the wave generator function by laser rangefinder

The interval eccentricity error correction model refers to the error model of the flexible bearing and the thickness of flexspline under eccentricity state, which is the interpolation function τ between standard value and eccentric value.

τ=β−β₁

β is the interval variation function under theoretical state; β₁ is the interval variation function under eccentricity state.

The interval variation function β under theoretical state:

$$\{ \begin{matrix}{ρ}_{1} = \frac{ab}{\sqrt{{a}^{2} {cos}^{2} φ + {b}^{2} {sin}^{2} φ}} \\ {ρ}_{2} = \frac{( a + Δ ) ( b + Δ )}{\sqrt{{( b + Δ )}^{2} {cos}^{2} φ + {( b + Δ )}^{2} {sin}^{2} φ}} \\ β = {ρ}_{2} - {ρ}_{1} \end{matrix} \qquad ( 1 \text{-} 4 )$$

therein Δ is the thickness.

The interval variation function β₁ under eccentricity state:

The elliptic function parameters a1 and b1 where the flexspline is located and the wave generator parameters a2 and b2 are respectively taken into the above formula (1-2), and (x₁, y₁) , (x₂, y₂) are respectively obtained and taken into the following formula, and) β₁=\sqrt{(x₁−x₂)²+(y₁−y₂)²} (1-5) is obtained.

W4. Measure coaxial standard circle and wave generator parameter C and flexspline deformation parameter E

The deformation parameters of coaxial standard circle, wave generator and flexspline are respectively measured by rotary table and laser rangefinder. The deformation function C of wave generator under eccentric action is obtained.

W5. Establish the correction model A1 under eccentricity state

The eccentricity (eₓ,e_{y}) is obtained by measured parameters of standard circle under eccentricity state and then taken to the formula to obtain the correction model A1 of the radial deformation function of the flexspline under eccentricity (eₓ,e_{y}) state.

W6. Corrected radial deformation function of flexspline

The radial deformation correction model A1 of the flexspline under eccentricity (eₓ,e_{y}) state established in W5 is taken to the flexspline deformation function model E measured under eccentricity state:

Q=E+A1

Q is the radial deformation function model of flexspline under standard state.

The advantages and positive effects of the invention are as follows:

The offset is obtained by analyzing the trajectory change of the standard circle under eccentricity state in the invention; the error parameter of wave generator in actual processing is obtained by analyzing the change of the standard ellipse under eccentricity state; taking the detection of the wave generator as the calibration reference, a more accurate deformation function model is obtained by correcting the deformation function of the flexspline under eccentricity state using a certain algorithm. The invention solves the problem exorbitant accuracy demands of the device.

What is claimed is:

1. A detection method for radial deformation of flexspline of harmonic reducer under installation eccentricity state, comprising the following steps:
W1. establish reference coordinate system;
taking a center of wave generator as an origin, a reference coordinate system O is established; in this coordinate, an eccentric coordinate of a pivotal center of rotary table is (eₓ,e_{y});
W2. establish a function model of standard circle and a function model of ellipse under theoretical eccentricity state;
1) standard circle under eccentricity state
in the reference coordinate system O, r is a radius of standard circle; eₓ is an offset of measuring line; r₀ is a radius of eccentric circle; d₀ is distance variation of measuring points;
θ is a rotation angle; the function model of standard circle under eccentricity state is as follows:
$$\{ \begin{matrix}{b}^{2} + {d}_{1}^{2} - 2 {bd}_{1} cos ( w ) = {r}^{2} \\ {d}_{1} - r - \sqrt{{r}^{2} - {e}_{x}^{2}} = {d}_{0} \end{matrix} \\ therein \text{:} cos δ = \frac{{e}_{x}}{{r}_{0}} ; cos ( w ) = \frac{{e}_{x} {r}_{0} cos ( δ - θ )}{{r}_{0}^{2} - b \sqrt{{r}_{0}^{2} - {e}_{x}^{2}}} \qquad ( 1 \text{-} 1 )$$
according to formula (1-1), the function model of standard circle under eccentricity state is obtained: d₀=f(θ); measured parameters of standard circle are respectively taken into formula (1-1) to obtain an offset of actual circle (eₓ, e_{y});
2) elliptic curve under eccentricity state;
the coordinate system is established with the ellipse center as the center, θ is the rotation angle, set a focus of a measuring line and an ellipse as (x, y), and the coordinate of the rotation center as (eₓ,−e_{y}) ;
$$\begin{matrix}( x , y ) = \{ \begin{matrix}\frac{{x}^{2}}{{a}^{2}} + \frac{{y}^{2}}{{b}^{2}} = 1 \\ cos δ = \frac{{e}_{x}}{\sqrt{{( x - {e}_{x} )}^{2} + {( y + {e}_{y} )}^{2}}} \\ cos δ = \frac{- x + {e}_{x}}{\sqrt{{( x - {e}_{x} )}^{2} + {( y + {e}_{y} )}^{2}}} \\ w + θ = δ \end{matrix} & ( 1 \text{-} 2 ) \\ d = \sqrt{{( x - {e}_{x} )}^{2} + {( y + {e}_{y} )}^{2} - {e}_{x}^{2}} & ( 1 \text{-} 3 )\end{matrix}$$
a wave generator function and offset (eₓ,e_{y}) are respectively taken into the above formula (1-2) and (1-3), actual ellipse parameters a and b can be obtained;
W3. establish a correction model A of a flexspline deformation function under theoretical eccentricity state;
in the reference coordinate system O, the correction model of flexspline deformation function under eccentricity state is obtained, which includes two parts: a correction model of wave generator eccentricity error and a correction model of interval eccentricity error;
A=D+τ
the eccentricity error model of wave generator is a differential function D between wave generator B under standard state and wave generator function model C under eccentricity state:
$$D = B - C$$
$$therein \text{:} B = \frac{ab}{\sqrt{{a}^{2} {cos}^{2} θ + {b}^{2} {sin}^{2} θ}}$$
C: measure a wave generator function by laser rangefinder;
the interval eccentricity error correction model refers to an error model of flexible bearing and thickness of flexspline under eccentricity state, which is an interpolation function τ between standard value and eccentric value;
τ=β−β₁
β is an interval variation function under theoretical state; β₁ is an interval variation function under eccentricity state;
the interval variation function β under theoretical state:
$$\{ \begin{matrix}{ρ}_{1} = \frac{ab}{\sqrt{{a}^{2} {cos}^{2} φ + {b}^{2} {sin}^{2} φ}} \\ {ρ}_{2} = \frac{( a + Δ ) ( b + Δ )}{\sqrt{{( b + Δ )}^{2} {cos}^{2} φ + {( b + Δ )}^{2} {sin}^{2} φ}} \\ β = {ρ}_{2} - {ρ}_{1} \end{matrix} \qquad ( 1 \text{-} 4 )$$
therein Δ is the thickness;
W4. measure coaxial standard circle and wave generator parameter C and flexspline deformation parameter E
deformation parameters of coaxial standard circle, wave generator and flexspline are respectively measured by rotary table and laser rangefinder; the deformation function C of wave generator under eccentric action is obtained;
W5. establish correction model A1 under eccentricity state
the eccentricity (eₓ,e_{y}) is obtained by measured parameters of standard circle under eccentricity state and then taken to the formula to obtain the correction model A1 of the radial deformation function of the flexspline under eccentricity (eₓ,e_{y}) state;
W6. corrected radial deformation function of flexspline
the radial deformation correction model A1 of the flexspline under eccentricity (eₓ,e_{y}) state established in W5 is taken to the flexspline deformation function model E measured under eccentricity state:
Q=E+A1
Q is the radial deformation function model of flexspline under standard state;

2. The detection method for radial deformation of flexspline of harmonic reducer under installation eccentricity state according to claim 1, wherein:
the interval variation function β₁ under eccentricity state:
the elliptic function parameters a1 and b1 where the flexspline is located and the wave generator parameters a2 and b2 are respectively taken into the above formula (1-2), and (x₁, y₁) (x₂, y₂) are respectively obtained and taken into the following formula, and β₁=\sqrt{(x₁−x₂)²+(y₁−y₂)²} (1-5) is obtained.
